(19) United States
(12) Patent Application Publication
(10) Pub. No.: US 2008/0034978 A1
(43) Pub. Date: Feb. 14, 2008

(54) Apparatus and Methods for Reshaping Cheese

(75) Inventors: David Webb Mehnert, Lake Villa, IL (US); Orestes Rivero, Skokie, IL (US)

Correspondence Address: FITCH EVEN TABIN & FLANNERY, 120 S. LASALLE STREET, SUITE 1600, CHICAGO, IL, 60603-3406, US

(73) Assignee: KRAFT FOODS HOLDINGS, INC., Northfield, IL (US)

(21) Appl. No.: 11/464,055

(22) Filed: Aug. 11, 2006

(51) Int. Cl. A47J 37/08

(52) U.S. Cl. 99/386

(57) ABSTRACT

A cheese reshaper is provided that reshapes a generally rectangular portion of cheese into a generally circular or ovular portion of cheese. The cheese reshaper consists of a cheese shaping die having a generally rectangular entrance opening and a generally circular exit opening with a transition zone therebetween. The transition zone is dimensional to gradually reshape the cheese as it passes through it. Furthermore, the cross-sectional areas of the generally rectangular portion of cheese, generally circular or ovular portion of cheese, generally rectangular entrance opening, and the generally circular or ovular exit opening are all substantially equal.

### FIELD

This disclosure relates generally to apparatus and methods for reshaping cheese, and more specifically to apparatus and methods for reshaping cheese portions having rectangular cross-sections into cheese portions having non-rectangular cross-sections.

### BACKGROUND

In the cheese manufacturing process, bulk cheese is traditionally provided in large rectangular blocks, often weighing up to 640 pounds. These large blocks are typically reduced into smaller portions of traditional cheese shapes or shreds suitable for consumer use. Traditional shapes for retail natural cheese may consist of uniform rectangular portions, such as chunks or sticks, or rounds, such as horns or moons, half moons or wedges. The texture and structure of the cheese can be more desirable when the cheese shapes are cut from a block rather than when the cheese shapes are made from combining smaller pieces into a larger piece of cheese.

Rectangular portions can be cut from the larger rectangular blocks of bulk cheese with high efficiency (i.e., little waste created). For example, no more than 10-20% of the larger block of cheese can be considered unusable when cutting it into smaller rectangular portions. This is because the smaller rectangular portions can be made using automated machinery by cutting the bulk cheese block in combinations of directions that are perpendicular and parallel to a machine feed direction to obtain the desired rectangular cheese portion.

Cutting circular cheese portions or logs from larger rectangular blocks of cheese can create significant amounts of waste and trim, such as residual edge trimmings. Such trimmings are either discarded or further processed in some manner, thus adding to the expense and logistical issues of manufacturing. Cutting circular portions of cheese from larger rectangular blocks can be highly inefficient. For example, 40-50% of the larger block of cheese can be considered unusable when cutting it down to smaller circular or semi-circular portions, such as cheese logs. This is because cutting round edges into a rectangular portion of cheese is often accomplished by slicing away the corner portions of the rectangular portion of cheese to create rounded edges. In shaping the rectangular portions of cheese in this way, residual trimmings created by cutting the corners of the cheese are often considered unusable since they cannot be reincorporated into the cheese log.

Reusing the residual trimmings can create additional expenses and/or logistical complications in manufacturing. For example, when the trimmings are reused by adding them to a processed cheese formulation as an ingredient the trimmings replace a cheaper raw material. This method can be more expensive because the trimmings consist of ready to eat cheese that already contains a certain quantity of raw materials and processing costs, whereas the raw material is merely a single, inexpensive ingredient. An example of logistical problems with reusing the residual trimmings is when the trimmings are added to packaged shredded cheese. This can create a problem unless the manufacturing schedule for shredding coincides with the schedule for trimming the rectangular portions of cheese into logs. Otherwise, the excess trim would have to be stored until shredding thus creating additional costs and constraints.

In addition, cutting a bulk block of cheese into numerous smaller rectangular portions also allows for easier storage of the cheese product after it is cut because the rectangular portions can be readily stacked on top of one another. By comparison, circular cheese logs that are created with existing methods can be tapered along the longitudinal axis, lacking a consistent width throughout the length of the cheese log. This can lead to difficulties when stacking multiple logs.

### SUMMARY

A cheese reshaper is provided that reshapes a generally rectangular portion of cheese into a generally circular or ovular portion of cheese while both reducing or substantially eliminating residual edge trimmings and reducing disturbance of the cheese structure. The cheese reshaping apparatus has a cheese shaping die with a transition zone located between a generally rectangular entrance and a generally circular exit. The transition zone is dimensioned to gradually reshape a generally rectangular portion of cheese into a generally circular portion of cheese. The entrance and exit openings may be substantially equal in cross-sectional areas as well as also being substantially equal to the cross-sectional areas of the generally rectangular cheese going into the die and the generally circular or ovular cheese coming out of the die.

In one aspect, the apparatus may include a ram that fits through the entrance opening and at least partially into the transition zone to advance the cheese forward through the die.

In another aspect, the cheese reshaping die has cutting elements fitted adjacent the exit opening to cut the cheese as it exits in a direction parallel to a machine direction. A further aspect of the cheese reshaping die has a cutting device at or near the exit opening to cut the cheese in a direction transverse to a machine direction.

### BRIEF DESCRIPTION OF THE DRAWINGS

FIG. 1A is a process flow diagram of an apparatus for reshaping a rectangular block of cheese into a generally circular cheese shape;

FIG. 1B is a perspective view of an opposite end the cheese shaping die from that shown in FIG. 1A;

FIG. 2 is a perspective view of an alternate embodiment of the cheese shaping die shown in FIG. 1A;

FIG. 3A is a side elevation view of a ram apparatus;

FIG. 3B is a front elevation view of the ram apparatus of FIG. 3A;

FIG. 4A is a perspective view of another embodiment of a cheese shaping die; and

FIG. 4B is a perspective view of another embodiment of a cheese shaping die.

### DETAILED DESCRIPTION OF THE DRAWINGS

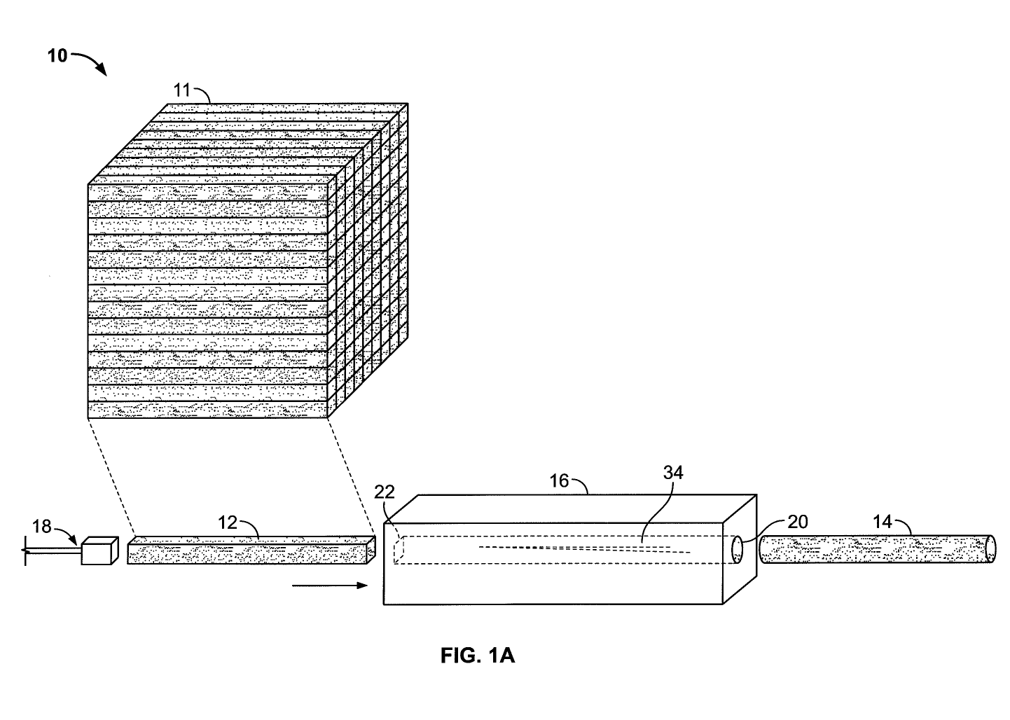

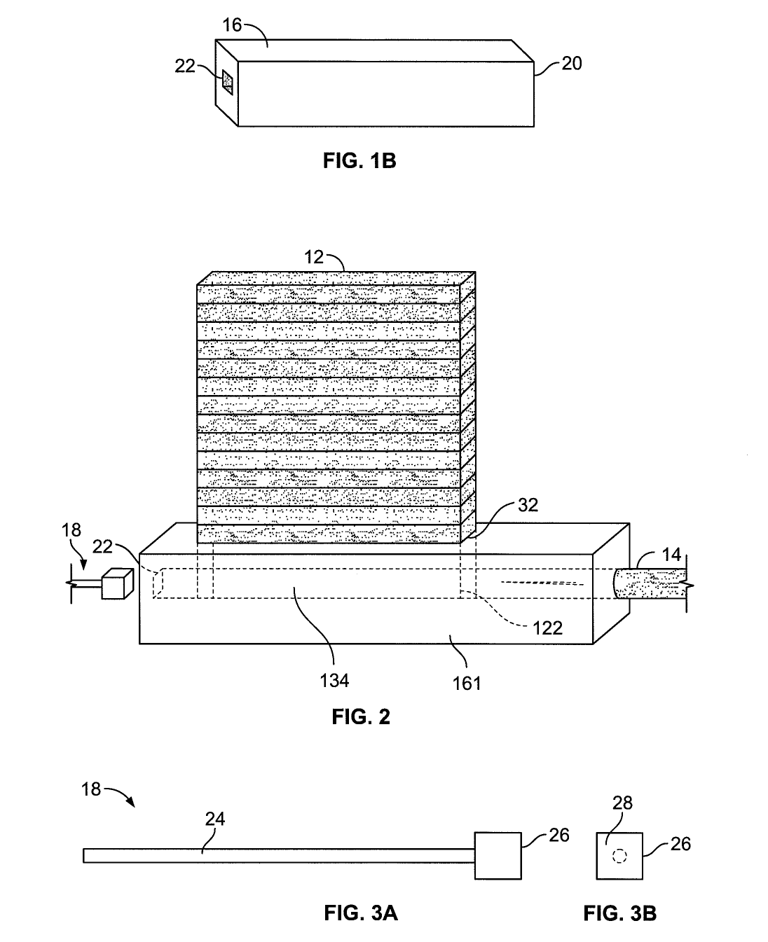

Apparatus and methods to reshape a generally rectangular portion of cheese into a generally circular portion of cheese using a cheese reshaping apparatus are disclosed herein and illustrated in FIGS. 1-4. The cheese reshaping apparatus includes a cheese reshaping die with a generally rectangular entrance opening and a generally circular exit opening, both of which have cross-sectional areas that are substantially equal to one another and to the cross-sectional area of the generally rectangular portion of cheese. The cheese reshaping apparatus further includes a ram sized to fit through the generally rectangular entrance opening to advance the cheese portion through the cheese reshaping die. The cheese reshaping apparatus eliminates the need to cut the corners of a rectangular cheese portion into round edges to create circular cheese, and thus substantially reduces or even eliminates residual edge trim.

The cheese reshaping apparatus 10, as illustrated in FIG. 1A, includes a cheese reshaping die 16 with a generally rectangular shaped entrance opening 22 (see FIG. 1B) at an upstream end and a generally circular or ovular shaped exit opening 20 (see FIG. 1A) at an opposite, downstream end. The die 16 itself may be of any shape externally, such as the generally rectangular external shape illustrated in FIGS. 1-4. A transition zone 34 is located between the entrance opening 22 and the exit opening 20 and is sized to accept a generally rectangular portion of cheese 12 and to reshape it into a generally circular or ovular portion of cheese 14 as it passes through the transition zone 34. This may be done by gradually changing the inner shape of the transition zone 34 from being generally rectangular to generally circular between the entrance opening 22 and the exit opening 20. As the cheese advances in a forward machine direction through the die 16, it is reshaped by conforming to the shape of the walls of the transition zone 34. The die 16 preferably shapes the entirety of the generally rectangular portions into generally circular portions of cheese and in particular it works the corners of the generally rectangular portions into round surfaces.

The length of the die 16 is preferably at least slightly longer than the length of the cheese 12 going into the die 16, such that the transition zone 34 may also be slightly longer in order to keep the cross-sectional areas of the exiting cheese substantially equal to that entering. If the transition zone 34 is too long the cheese may experience shear from the surfaces of the transition zone which can undesirably alter the structure of the cheese and adversely impact flavor.

The generally rectangular opening 22 is sized to receive the generally rectangular portion of cheese 12 as it enters the die 16 and is advanced in a machine direction through the transition zone 34. The generally rectangular opening 22 may also contain a funnel-like opening, such that it is tapered slightly outwards at the edge of the opening 22. The cross-sectional area of the entrance opening 22, which is transverse to the machine direction, is substantially equal to the cross-sectional area of the generally rectangular portion of cheese 12. As will be discussed later in more detail, the cross-sectional area of the exit opening 20 can also be substantially equal to the cross-sectional areas of both the entrance opening 22 and the generally rectangular portion of cheese 12.

The generally rectangular portion of cheese 12 is typically cut from a larger block of cheese 11, weighing up to about 640 pounds and having dimensions of, for example, about 28 inches in length, about 30 inches in height, and about 22 inches in width. This larger rectangular block of cheese 11 can be typically cut with wires or knives to yield smaller, generally rectangular portions of cheese 12

The generally rectangular portion of cheese 12 is advanced through the entrance opening 22 of the die 16 in a machine direction through the transition zone 34 by applying a force to an end of the cheese 12 by using a selectively advanceable ram or piston 18, as shown in FIGS. 1A and 3A. The material of construction of the die 16 may be metal or plastic suitable for contact with food, such as stainless steel, Teflon, polyester, or nylon. The ram 18 may have a handle or rod 24 attached to the end of the ram head 26 which is placed against an end of the cheese 12. A cross-section of the ram head 26 may be shaped and sized similarly to the cross-section of the generally rectangular portion of cheese 12 and the cross-section of the entrance opening 22. The ram 18 may have the same dimensions as the cheese 12 so that it can push the cheese in a machine direction into the transition zone until the shape of the transition zone changes such that the ram 18 cannot fit any further beyond a certain point. The ram 18 pushes the cheese 12 through the transition zone 34 as far as the shape of the transition zone 34 allows, to make room for the next piece of cheese 12.

For example, the ram head 26 may also have a generally rectangular shape, and more preferably the ram head 26 may have the same dimensions (i.e., height and width) as the cheese 12 and the entrance opening 22, In that case, the ram head 26 is limited in how far through the transition zone 34 it can advance due to the gradually changing dimensions of the transition zone 34.

The ram face 28, as shown in FIG. 3B, is located on an end of the ram head 26 that is opposite the handle 24, and is at the side of the ram head 26 that contacts the cheese 12. The ram face 28 is placed against the end of the cheese 12 that is opposite the end that has already entered the die 16 at the entrance opening 22. A force may be applied to the end of the cheese 12 to aid in advancing the cheese 12 through the transition zone. For example, a force of about 50 psi to about 150 psi may be applied to the cheese 12. The ram 18 may also partially enter into the transition zone as it continues to apply a force to the cheese 12 to advance it forward through the die 16, and preferably may almost completely enter the die 16. Additionally, each subsequent piece of cheese can be used to push the previous piece of cheese ahead of it through the die 16 and out through the exit opening 20.

Alternatively, the ram head 26 may also fit in the entire transition zone 34 of the die 16, but to do so the ram head 26 needs to be smaller in cross-sectional area than the generally rectangular cheese 12 and sized such that it may fit along the entire length of the transition zone 34. Since the transition zone 34 may vary gradually from generally rectangular to generally circular, the ram head 26 can be shaped such that it may pass through both regions to be able to fit through the different shaped regions of the transition zone 34 from entrance 22 to exit 20.

An alternate embodiment of the die is shown in FIG. 2, which can support a feed of multiple cheese portions 12 into the die in a direction transverse to the machine direction. The cheese 12 may enter the die 161 through a feed opening 32 that may be generally rectangular and located along a length of the die 161 parallel to a machine direction, and preferably from a top section of the die 161 such that as the cheese 12 is inserted into the die 161 it travels in a direction transverse to the machine direction. The feed opening 32 may be sized to receive the generally rectangular cheese 12 and is located upstream from the transition zone 134. The length of the feed opening 32 may be substantially the same length as the length of cheese 12. As the cheese 12 is fed into the transition zone 134 by hand or automated, a ram 18 may enter the die 161 through the entrance opening 22 and advance in a machine direction applying a force to the cheese 12 to push it through an inner entrance opening 122 and through the transition zone 134, also in a machine direction, and out the exit opening 20, similar to the process discussed above.

For both die embodiments 16 and 161, the cheese emerges out from the exit opening 20 as a generally circular portion of cheese 14. In reshaping the cheese 12 in this manner, disturbance of the cheese structure can be minimized and minimal to no residual edge trim is generated. The cross-sectional area of the generally circular exit opening 20, which is transverse to the machine direction, is substantially equal to the cross-sectional area of the entrance opening 22, which in turn is substantially equal to the cross-sectional area of the generally rectangular portion of cheese 12 and the generally circular portion of cheese 14.

As a result of the cross-sectional areas of the exit and entrance openings 20 and 22 being substantially equal, the cross-sectional areas of the generally rectangular portion of cheese 12 and the generally circular portion of cheese 14 are substantially equal. The generally circular portion of cheese 14 may be about the same length as the generally rectangular portion of cheese 12. The generally circular portion of cheese 14 may have a diameter such that the generally circular cheese 14 may have a substantially equal cross-sectional area to that of the generally rectangular cheese 12.

The relationship between the generally rectangular cheese 12, the generally circular cheese 14, and the two die openings 20 and 22 may be defined by formulas. The generally rectangular portion of cheese 12 has a width (w) and a height (h) that are generally transverse to the machine direction, and a length that is generally parallel to the machine direction. The entrance opening 22 of the die 16 is generally sized to accommodate the width and the height of the generally rectangular portion of cheese 12. The exit opening 20 of the die 16 has a radius (r). The relationship between the radius (r) of the exit opening 20 and the dimensions (h) and (w) of the generally rectangular portion of cheese 12 may be defined by the following formulas: w/2≦r≦((w/2)²+(h/2)²)^{1/2} and h/2≦r≦((w/2)²+(h/2)²)^{1/2}. Furthermore, the cross-sectional areas of the two openings 20 and 22 and the generally rectangular cheese 14 and the generally circular cheese 12 may all have substantially equal cross-sectional areas defined by (h)×(w).

Similarly, the relationships may be defined by another formula for cheese that is not circular upon exiting the die and where the generally rectangular portion of cheese 12 may have a major dimension (dₘₐⱼₒᵣ) and a minor dimension (dₘᵢₙₒᵣ) generally transverse to the machine direction. The entrance opening 22 may be sized to accommodate the major dimension (dₘₐⱼₒᵣ) and the minor dimension (dₘᵢₙₒᵣ) of the generally rectangular portion of cheese 12.

The exit opening 20 of the die 16 can have a major radius (rₘₐⱼₒᵣ) and a minor radius (rₘᵢₙₒᵣ) where the exit opening also is not circular. The relationship between the major radius (rₘₐⱼₒᵣ) of the exit opening 20 and the major dimension (dₘₐⱼₒᵣ) of the generally rectangular portion of cheese may be defined by the formula dₘₐⱼₒᵣ/2≦rₘₐⱼₒᵣ<((dₘₐⱼₒᵣ/2)²+(dₘᵢₙₒᵣ/2)²)^{1/2}. The relationship between the minor radius (rₘᵢₙₒᵣ) of the exit opening 20 and the minor dimension (dₘᵢₙₒᵣ) of the generally rectangular portion of cheese 12 may be defined by the formula dₘᵢₙₒᵣ/2≦rₘᵢₙₒᵣ≦((dₘₐⱼₒᵣ/2)²+(dₘᵢₙₒᵣ/2)²)^{1/2}.

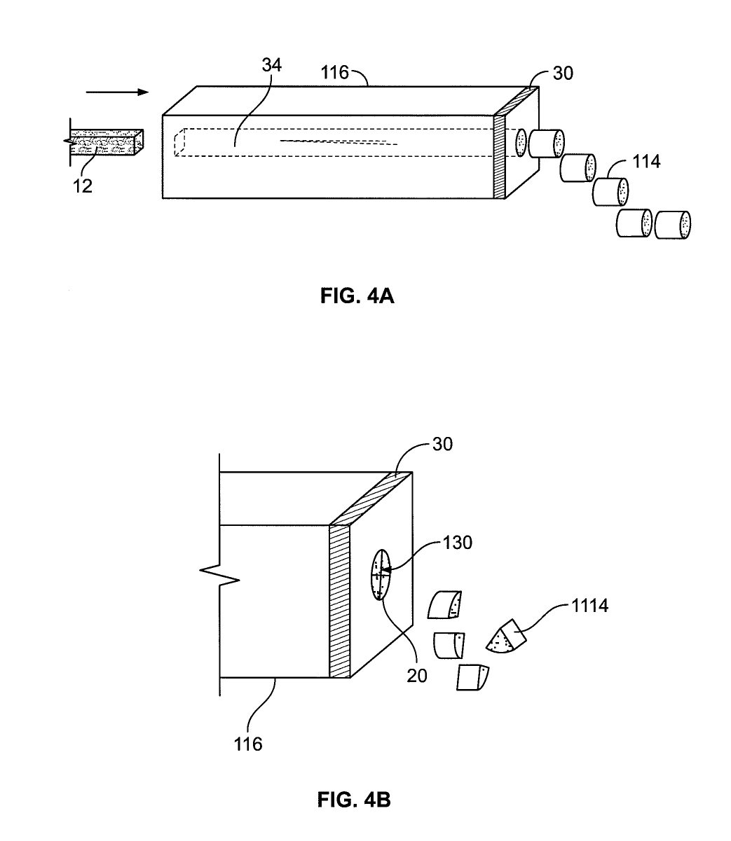

The generally circular portions of cheese that exit the die 16 may be further cut into smaller dimensioned portions of generally circular cheese, as illustrated in FIG. 4A. The generally circular cheese 14 may be sliced as the cheese 14 exits the die 16, thus creating smaller length circular portions of cheese 114, such as full moon cheese shapes. The cutting device 30 may be placed adjacent the exit opening 20 such that it slices through the generally circular portions of cheese 14 in a direction transverse to the machine direction as they are exiting the die 16. The timing of the cuts can be such that it allows a certain predetermined length of cheese to pass through the exit opening 20 before activating the cutting device to cut the cheese into smaller cheese portions 114 of substantially equal length. For example, the activation of the cutting device may be based upon the speed of the ram 18 so that the cutting device cuts the cheese based upon the advancement rate of the ram. The knife may be positioned at a top side of the die 16 such as a side parallel to the machine direction, for example, so that when it slices through the generally circular portion of cheese the knife cuts through it with a downward cutting motion. As the generally circular portions of cheese are cut, they emerge from the die 16 through the exit opening 20 as smaller length circular portions of cheese 114 having diameters substantially equal to the diameter of the exit opening 20.

Alternatively, the cutting device may be placed inside the transition zone near the exit opening 20, where the cutting device cuts the cheese into smaller length portions of cheese just prior to exiting the die. A further alternative can be to supply a cutting device at another location further downstream from the reshaping apparatus 10.

In another alternative illustrated in FIG. 4B, the cheese 14 may be cut into smaller cross-sections of cheese upon exiting the transition zone 34 through the exit opening 20. The exit opening 20 may be fitted with one or more cutting elements, such as wires or blades 130 for example, placed over the exit opening 20 that cut the generally circular portion of cheese 14 in a machine direction as it exits the transition zone 34 of the die 16. The generally circular cheese 14 is cut as it is being forced through the exit opening 20 and between the wires 130 that are attached across the exit opening 20. For example, if one wire is placed across the exit opening 20 from one side of the opening to the other along its perimeter, its length across the opening would be substantially equivalent to the diameter of the exit opening 20, and the wire can slice the generally circular portion of cheese 14 into two halves, or two half moons of cheese. The cut cheese 114 emerges in long strips where the length would be substantially equal to the length of the generally rectangular cheese 12 going into the die 16, and therefore it may be desirable to shorten the length of the cheese 114 that comes through the exit opening 20, either by also incorporating the previous embodiment with a cutting device 30 located inside or just outside the transition zone 34 or by using a cutting device externally located to the reshaping apparatus 10. Another example may include four wires placed across the exit opening 20 which would then cut the generally circular cheese 14 into eight wedge pieces of cheese upon exiting the die 16, or two wires 130, as shown in FIG. 4B, yielding four wedge pieces 114.

In one example of the cheese reshaper, the cross-sectional area of the generally rectangular portion of cheese 12 may be between about 3.5 sq. in. to about 6.0 sq. in. The generally rectangular portions of cheese 12 may have dimensions of, for example, about 28 inches long, about 2.2 inches wide, and about 2.2 inches high. Typical ranges of the dimension of the generally rectangular portion of cheese 12 may be a length of about 18 inches to about 38 inches, and a width and a height of about 1 inch to about 3.5 inches. Typically the diameter of the generally circular cheese 14 may be between about 1.5 inches to about 3.5 inches. Natural or processed cheese may be used, and cheeses such as cheddars (sharp, medium, and mild), American, Monterey Jack, Colby, and other similar cheeses may be used.

The cross-sectional area of the generally circular exit opening 20 may also be between about 3.5 sq. in. to about 6.0 sq. in., and preferably about 4.9 sq. in. where the cross-sectional area of the entrance opening 22 and the generally rectangular portion of cheese 12 have similar dimensions. The ram head 26 may have similar generally rectangular portions of cheese 12, such that if the cheese 12 has a substantially equal height and width of about 2.2 inches, for example, then the ram head 26 may also have a substantially equal height and width of about 2.2 inches.

### EXAMPLE

An example of a cheese reshaping die for reshaping a rectangular piece of cheese into a circular piece of cheese is as follows: the rectangular piece of cheese has a height and width of 2.2 inches and a length of 28 inches; the circular piece of cheese has a diameter of 2.5 inches; the rectangular entrance opening is similarly dimensional as the rectangular piece of cheese and also has a height and width of 2.2 inches. Furthermore, the circular exit opening is similarly dimensional as the circular piece of cheese. These parameters are summarized in the below table::

| | Height | Width | | |
|---|---|---|---|---|
| | (in.) | (in.) | Diameter (in.) | Area (sq. in.) |
| rectangular cheese | 2.2 | 2.2 | — | 4.9 |
| rectangular entrance | 2.2 | 2.2 | — | 4.9 |
| circular exit | — | — | 2.5 | 4.9 |
| circular cheese | — | — | 2.5 | 4.9 |

From the foregoing it will be appreciated that a cheese reshaping apparatus and methods are provided that allows for feeding a generally rectangular portion of cheese into a die which reshapes the cheese into a generally circular or ovular portion of cheese. However, the disclosure is not limited to the aspects and embodiments described hereinabove, or to any particular embodiments. Various modifications to the cheese reshaping apparatus and methods can result in substantially the same cheese product.

1. A cheese reshaping apparatus for converting a generally rectangular portion of cheese into a generally circular portion of cheese, the apparatus comprising:
a cheese shaping die having a generally rectangular entrance opening and a generally circular exit opening at opposite ends;
a transition zone located between the entrance opening and the exit opening where the transition zone is dimensioned to shape a generally rectangular portion of cheese into a generally circular portion of cheese; and
a selectively advanceable ram sized to fit through the entrance opening and partially in the transition zone to force the generally rectangular portion of cheese through the transition zone such that disturbance to a structure of the cheese is minimized and substantially no trimmings are created.

2. The cheese reshaping apparatus of claim 1 further comprising a generally rectangular feed opening along a length of the die parallel to a machine direction sized to receive the generally rectangular portion of cheese.

3. The cheese reshaping apparatus of claim 2, wherein a length of the feed opening is substantially equal to a length of the generally rectangular portion of cheese.

4. The cheese reshaping apparatus of claim 1, wherein the generally rectangular portion of cheese has a cross-sectional area between about 3.5 sq. in. and about 6.0 sq. in., and the exit opening has a cross-sectional area that is substantially equal to the cross-sectional area of the generally rectangular portion of cheese and is substantially equal to a cross-sectional area of the entrance opening.

5. The cheese reshaping apparatus of claim 1, wherein an end of the ram is generally rectangular shaped and is sized to fit through the entrance opening.

6. The cheese reshaping apparatus of claim 1, wherein the generally circular portion of cheese has a diameter between about 1.5 inches to about 3.5 inches and the generally rectangular portion of cheese has a width between about 1 inch to about 3.5 inches, a length between about 18 inches and about 38 inches, and a height between about 1 inch and about 3.5 inches.

7. The cheese reshaping apparatus of claim 1, wherein the exit opening is fitted with one or more cutting elements to cut the generally circular portion of cheese parallel to a machine direction as it exits the die.

8. The cheese reshaping apparatus of claim 7, wherein the cutting elements are wires extending transverse to the machine direction.

9. The cheese reshaping apparatus of claim 1, wherein the die has a cutting device positioned at or near the exit opening to cut the generally circular portion of cheese in a transverse direction to a machine direction.

10. The cheese reshaping apparatus of claim 1, wherein the generally rectangular portion of cheese has a length, a width (w) and a height (h), the length being generally parallel to a machine direction and the width (w) and height (h) being generally transverse to the machine direction, the entrance opening of the cheese shaping die generally being sized to accommodate the width (w) and height (h) of the generally rectangular portion of cheese and the exit opening of the cheese shaping die has a radius (r), the relationship between the radius (r) of the exit opening of the cheese shaping die and the width (w) and height (h) of the generally rectangular portion of cheese being satisfied by the following formulas: w/2≦r≦((w/2)²+(h/2)² )² and h/2≦r≦((w/2)²+(h/2)²)/^{1/2}.

11. A method of producing generally circular portions of cheese from a generally rectangular portion of cheese, the method comprising:
feeding a generally rectangular portion of cheese past an entrance opening of a cheese shaping die in a machine direction, the generally rectangular portion of cheese having a length, a width (w) and a height (h), the length being generally parallel to the machine direction and the width (w) and height (h) being generally transverse to the machine direction, the entrance opening of the cheese shaping die generally being sized to accommodate the width (w) and height (h) of the generally rectangular portion of cheese; and
feeding the generally rectangular portion of cheese through a transition zone of the cheese shaping die between the entrance opening and a generally circular exit opening and out the exit opening, the transition zone being dimensioned to shape the generally rectangular portion of cheese into a generally circular portion of cheese, the exit opening of the cheese shaping die having a radius (r), the relationship between the radius (r) of the exit opening of the cheese shaping die and the width (w) and height (h) of the generally rectangular portion of cheese being satisfied by the following formulas: w/2≦r≦((w/2)²+(h/2)²)^{1/2} and h/2≦r≦((w/2)²+(h/2)²)^{1/2}.

12. The method of claim 11, wherein the entrance opening of the cheese shaping die has an area transverse to the machine direction that is substantially equal to an area of the exit opening of the cheese shaping die transverse to the machine direction and is substantially equal to an area of the generally rectangular portion of cheese defined by (h)×(w).

13. The method of claim 11, wherein the entrance opening of the cheese shaping die has a cross-sectional area that is substantially equal to that of a cross-sectional area of the exit opening of the cheese shaping die, and is substantially equal to a cross-sectional area of the generally rectangular portion of cheese, the areas being between about 3.5 square inches and about 6.0 square inches.

14. The method of claim 11 further comprising applying a force to the generally rectangular portion of cheese using a ram sized to fit through the entrance opening of the cheese shaping die and into the transition zone.

15. The method of claim 11 further comprising cutting the generally circular portion of cheese in a machine direction into smaller cross-sections of cheese upon exiting the cheese shaping die through the exit opening.

16. The method of claim 15, wherein one or more wires are placed over the exit opening to cut the cheese as it exits the transition zone.

17. The method of claim 11 further comprising cutting the generally circular portion of cheese in a transverse direction to the machine direction into smaller length circular portions of cheese with diameters substantially equal to the diameter of the exit opening.

18. A method of producing generally ovular portions of cheese from a generally rectangular portion of cheese, the method comprising:
feeding a generally rectangular portion of cheese past an entrance opening of a cheese shaping die in a machine direction, the generally rectangular portion of cheese having a length, a major dimension (dₘₐⱼₒᵣ) and a minor dimension (dₘᵢₙₒᵣ), the length being generally parallel to the machine direction and the major dimension (dₘₐⱼₒᵣ) and minor dimension (dₘᵢₙₒᵣ) being generally transverse to the machine direction, the entrance opening of the cheese shaping die generally being sized to accommodate the major dimension (dₘₐⱼₒᵣ) and minor dimension (dₘᵢₙₒᵣ) of the generally rectangular portion of cheese; and
feeding the generally rectangular portion of cheese through a transition zone of the cheese shaping die between the entrance opening and a generally ovular exit opening and out the exit opening, the transition zone being dimensioned to shape the generally rectangular portion of cheese into a generally ovular portion of cheese, the exit opening of the cheese shaping die having a major radius (rₘₐⱼₒᵣ) and a minor radius (rₘᵢₙₒᵣ), the relationship between the major radius (rₘₐⱼₒᵣ) of the exit opening of the cheese shaping die and the major dimension (dₘₐⱼₒᵣ) of the generally rectangular portion of cheese being satisfied by the following formula: dₘₐⱼₒᵣ/2≦rₘₐⱼₒᵣ≦((dₘₐⱼₒᵣ/2)²+(dₘᵢₙₒᵣ/2)²)^{1/2} and the relationship between the minor radius (rₘᵢₙₒᵣ) of the exit opening of the cheese shaping die and the minor dimension (dₘᵢₙₒᵣ) of the generally rectangular portion of cheese being satisfied by the following formula: dₘᵢₙₒᵣ/2≦rₘᵢₙₒᵣ≦((dₘₐⱼₒᵣ/2)²+(dₘᵢₙₒᵣ/2)²)^{1/2}.

19. A method of producing generally circular portions of cheese, the method comprising:
providing a block of cheese;
cutting the block of cheese into generally rectangular portions;
feeding the rectangular portions through a die using a piston, the die shaping the entirety of the rectangular portions into the generally circular portions.

20. The method of claim 19 further comprising cutting the generally circular portions of cheese into smaller dimensioned portions of cheese.
